(19) United States
(12) Patent Application Publication
(10) Pub. No.: US 2009/0071272 A1
(43) Pub. Date: Mar. 19, 2009

(54) Ball screw device having circulating device

(75) Inventors: Chung Hsueh Lin, Taichung (TW); Jui Long Hsu, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 11/901,561

(22) Filed: Sep. 18, 2007

(51) Int. Cl. F16H 25/22; F16H 25/24; F16H 57/04

(52) U.S. Cl. 74/89.44; 74/424.86; 74/424.87

(57) ABSTRACT

A ball screw device includes a screw shaft rotatably engaged with a ball nut, and a number of bearing members received between the ball nut and the screw shaft, and a circulating device for circulating the bearing members, the circulating device includes a tubular member having two end blocks for engaging into the ball nut and having a passage for receiving the bearing members, and having an anti-symmetric structure formed by two half members, and each half member is formed by two half segments each having a portion of the passage of the half member for allowing the half segments of the half member to be precisely formed with molding processes.

### BACKGROUND OF THE INVENTION

1. Field of the Invention

The present invention relates to a ball screw device, and more particularly to a ball screw device having a molded circulating device for effectively and smoothly receiving and guiding the balls or the rollers or the bearing members to move relative to the ball nut and the screw shaft, and for facilitating the rotational movement of the ball nut and the screw shaft relative to each other in great rotational speeds.

2. Description of the Prior Art

Typical ball screw devices comprise a ball nut rotatably and/or moveably engaged onto a screw shaft, and normally arranged to allow the ball nut to be rotated and/or moved relative to the screw shaft in great rotational speeds. For allowing the ball nut to be smoothly rotated and moved relative to the screw shaft, a suitable bearing device or lubricating structure is further required to be provided and engaged between the ball nut and the screw shaft, for facilitating the rotational movement between the ball nut and the screw shaft.

For example, U.S. Pat. No. 3,971,2648 to Detraz et al. discloses one of the typical screw-and-nut mechanism with ball or roller recirculation including a ball recirculation channel comprising bent, tubular inlet and outlet elements connected to each other by a connecting means, the tubular elements being engaged in a bore of the nut member in such a way as to emerge at the bottom of the thread.

However, the tubular elements are required to be bent from a longitudinal tubular member, and the corner areas or the bent portions of the tubular elements may be distorted such that the balls or the rollers or the bearing members may not suitably move through the tubular elements.

U.S. Pat. No. 4,953,419 to Schlenker, and U.S. Pat. No. 5,063,809 to Schlenker disclose two further typical ball screw and nut assemblies each including a ball return tube having one or more bent portions or elbows for guiding the balls or the rollers or the bearing members.

However, similarly, the return tubes are also required to be bent from a longitudinal tubular member, and the corner areas or the bent portions of the return tubes may be distorted such that the balls or the rollers or the bearing members may not suitably move through the return tubes.

U.S. Pat. No. 5,014,568 to Schlenker discloses a still further typical ball screw and nut assembly including a deflector having a curved and elongate body, and a threaded stem rigidly affixed to the body and integral with the body, and one or more transfer tubes for guiding the balls or the rollers or the bearing members.

However, similarly, the transfer tubes are also required to be bent from a longitudinal tubular member, and the corner areas or the bent portions of the transfer tubes may be distorted such that the balls or the rollers or the bearing members may not suitably move through the transfer tubes.

U.S. Pat. No. 6,023,991 to Tabe et al. discloses a still further typical ball screw device also including one or more circulation tubes for guiding the balls or the rollers or the bearing members.

However, similarly, the circulation tubes are also required to be bent from a longitudinal tubular member, and the corner areas or the bent portions of the circulation tubes may be distorted such that the balls or the rollers or the bearing members may not suitably move through the circulation tubes.

The present invention has arisen to mitigate and/or obviate the afore-described disadvantages of the conventional ball screw devices for such as machine tools or the like.

### SUMMARY OF THE INVENTION

The primary objective of the present invention is to provide a ball screw device including a molded circulating device for effectively and smoothly receiving and guiding the balls or the bearing members to move relative to the ball nut and the screw shaft, and for facilitating the rotational movement of the ball nut and the screw shaft relative to each other in great rotational speeds.

The other objective of the present invention is to provide a ball screw device including a molded circulating device having a structure for allowing the circulating device to be easily and quickly and precisely formed or made with the molding or mold-injection procedures and to be easily and quickly and readily removed or disengaged from the mold devices.

In accordance with one aspect of the invention, there is provided a ball screw device comprising a screw shaft including an outer thread formed thereon, a ball nut including a bore formed therein for receiving the screw shaft, and including an inner thread formed therein for forming a helical raceway between the ball nut and the screw shaft, the ball nut including two openings formed therein and communicating with the bore of the ball nut, a plurality of bearing members received in the helical raceway between the ball nut and the screw shaft for facilitating a rotating movement between the ball nut and the screw shaft, and a circulating device including a tubular member having two end blocks for engaging into the openings of the ball nut, the tubular member including a passage formed therein and directed toward the inner thread of the ball nut and the outer thread of the screw shaft for receiving the bearing members, the circulating device includes an anti-symmetric structure formed by two identical half members, and each half member is formed by two half segments each having a portion of the passage of the half member for allowing the half segments of the half member to be precisely formed with molding procedures and to be easily and quickly and readily removed or disengaged from the mold devices.

The end blocks of the circulating device each include a compartment formed therein for receiving a lubricating oil therein. The end blocks of the circulating device each include a cap for closing the compartment of the end block and for retaining the lubricating oil in the compartment of the end block.

The end blocks of the circulating device each include a groove formed therein and communicating with the compartment of the block and communicating with the passage of the tubular member for allowing the lubricating oil in the compartment of the block to flow into the passage of the tubular member and then to flow into the inner thread of the ball nut and the outer thread of the screw shaft.

The end blocks of the circulating device each include an oil retaining member engaged into the groove of each of the end blocks of the circulating device.

The end blocks of the circulating device each include a deflecting tongue provided therein for forming a portion of the passage of the tubular member and for directing the passage of the tubular member toward the inner thread of the ball nut and the outer thread of the screw shaft.

The circulating device includes at least one ear extended from the tubular member and having an orifice formed therein for engaging with a fastener which detachably secure the circulating device to the ball nut. The two half members each include one half of the ear provided thereon.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a ball screw device in accordance with the present invention;

FIG. 2 is another partial perspective view of the ball screw device, in which one half of the outer ball nut has been cut off for showing an inner structure of the ball screw device;

FIG. 3 is a perspective view of the ball screw device, in which a screw shaft has been removed or not shown in the drawing figure;

FIG. 4 is a perspective view illustrating the circulating device of the ball screw device;

FIGS. 5, 6 are perspective views illustrating one half of the circulating device of the ball screw device;

FIGS. 7, 8 are perspective views illustrating one of two segments of each half of the circulating device of the ball screw device; and

FIGS. 9, 10 are perspective views illustrating the other segment of each half of the circulating device of the ball screw device.

### DETAILED DESCRIPTION OF THE PREFERRED EMBODIMENT

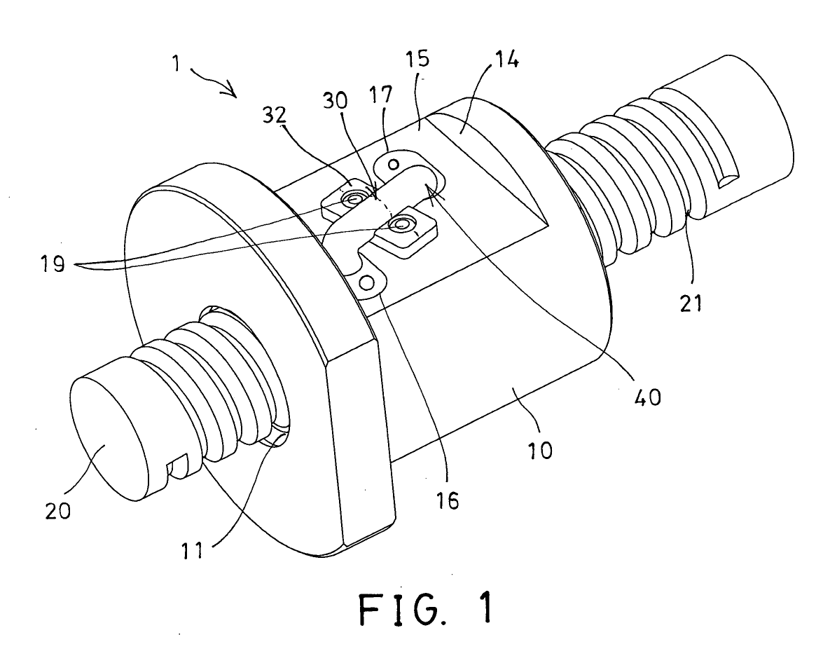

Referring to the drawings, and initially to FIGS. 1-3, a ball screw device 1 in accordance with the present invention comprises an outer ball nut 10 including a bore 11 formed therein for receiving a typical screw shaft 20 and having an inner thread 12 formed therein for threading with or for engaging with an outer thread 21 of the screw shaft 20 and for allowing the ball nut 10 to be moved along the screw shaft 20, or for allowing the screw shaft 20 to be rotated and moved relative to the ball nut 10. The threading engagement and/or the rotational engagement between the ball nut 10 and the screw shaft 20 is typical and will not be described in further details.

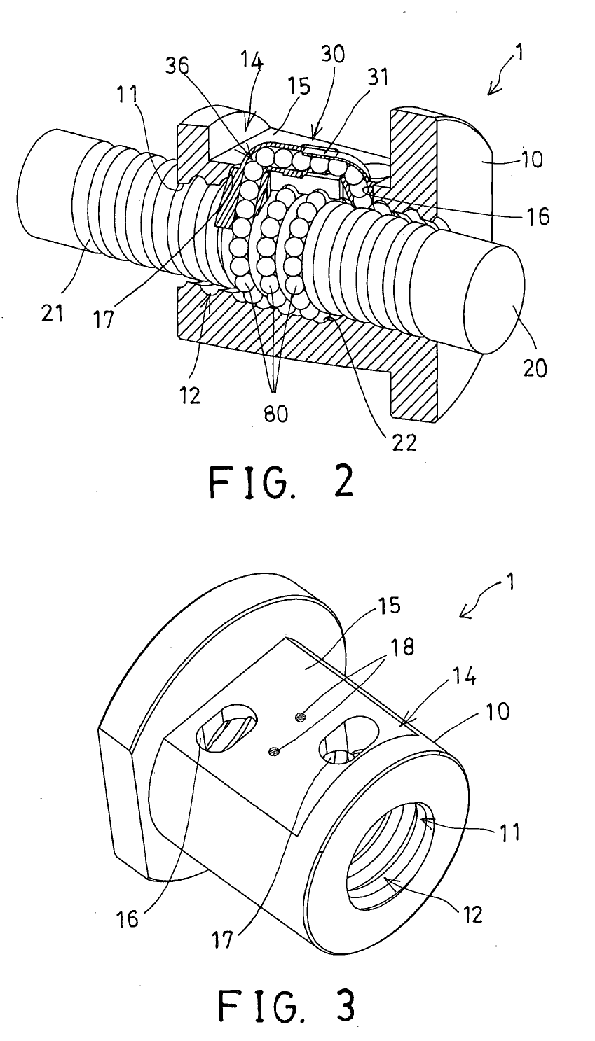

A multiple turn, helical raceway 22 will be formed between the ball nut 10 and the screw shaft 20 for rotatably and/or movably receiving one or more groups of balls or rollers or rolling or ball bearing members 80 (FIG. 2) therein which may facilitate the rotating movement of the ball nut 10 relative to the screw shaft 20 when the screw shaft 20 is forced to rotate relative to the ball nut 10 or when the ball nut 10 is forced to rotate relative to the screw shaft 20.

The ball nut 10 includes a cut off portion or a recess 14 formed in the outer peripheral portion thereof, and formed or defined by a flat surface 15, and includes two openings 16, 17 formed therein and communicating with the bore 11 of the ball nut 10 (FIG. 3), and one or more (such as two) screw holes 18 formed therein each for threading with or for engaging with a fastener 19 (FIG. 1), and for attaching or securing or mounting a ball guide or circulating device 30.

The circulating device 30 includes a bent or curved or tubular member 31, one or more (such as two) ears 32 extended from the tubular member 31 and each having an orifice 33 formed therein for engaging with the fasteners 19 (FIG. 1) which may be threaded or engaged with the screw holes 18 of the ball nut 10 for detachably securing the circulating device 30 to the ball nut 10, and further includes two end blocks 34 formed or provided or attached or secured to the two end portions 35 of the tubular member 31 for engaging into the openings 16, 17 of the ball nut 10 and for allowing the circulating device 30 to be stably anchored or secured or mounted or positioned to the ball nut 10.

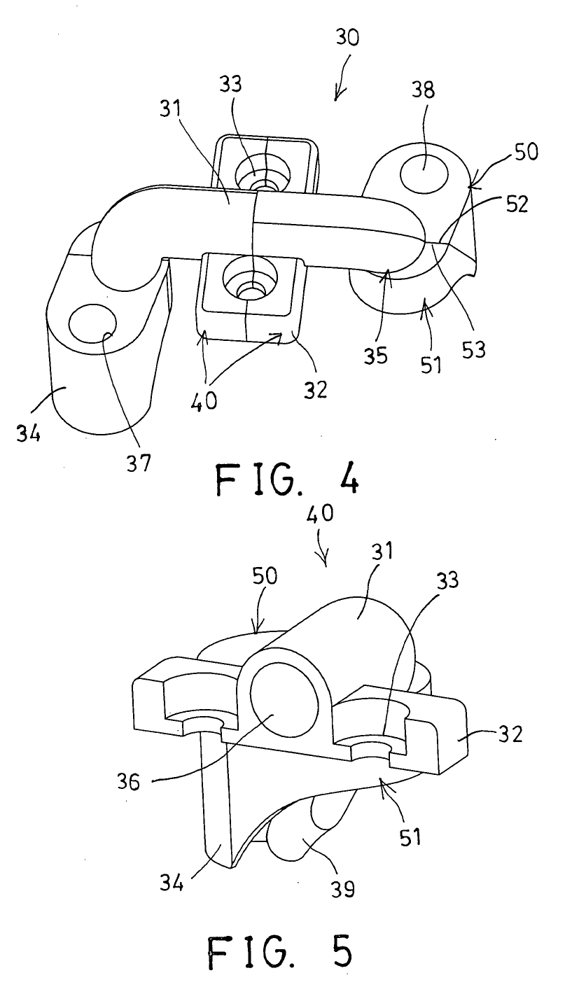

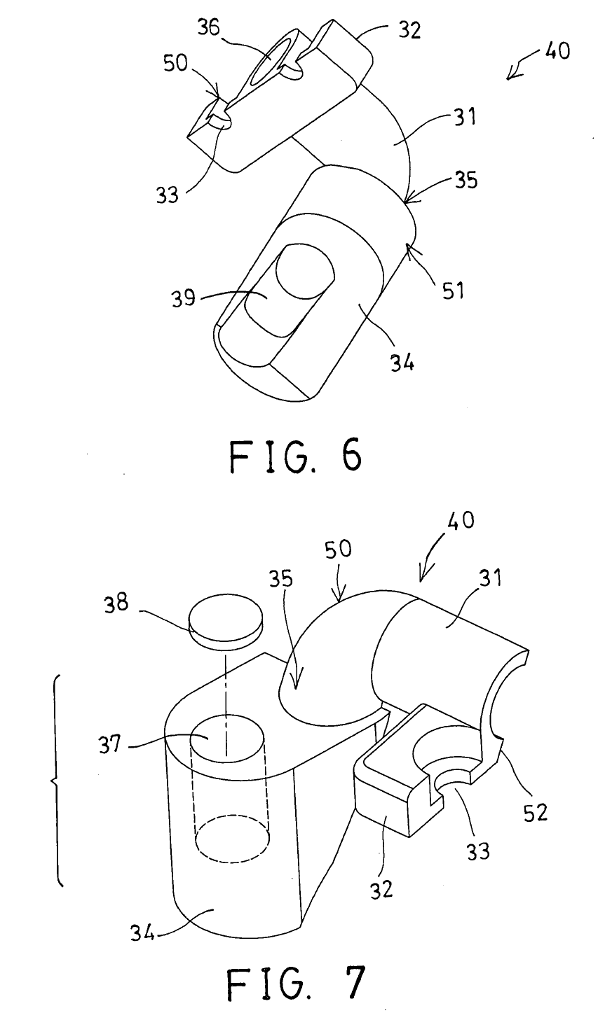

As shown in FIGS. 2 and 5-6, the tubular member 31 includes a passage 36 formed therein and directed toward the inner thread 12 of the ball nut 10 and the outer thread 21 of the screw shaft 20 for rotatably and/or movably receiving one or more groups of balls or rollers or rolling or ball bearing members 80 therein and for allowing the ball bearing members 80 to form an endless ball train. The blocks 34 each include a pathway or compartment 37 formed therein (FIGS. 4, 7) for receiving a lubricating oil or lubricant therein, and a cap 38 for enclosing or closing the compartment 37 of the block 34 and for sealingly retaining the lubricating oil or lubricant therein in the compartment 37 of the block 34.

As shown in FIGS. 1 and 4, the circulating device 30 includes an anti-symmetric structure formed by two identical half members 40 (FIGS. 5, 6) that include the same structure or configuration for allowing the half members 40 to be easily and quickly formed or made with such as molding or mold-injection procedures and with the same mold device. The two half members 40 may be secured together with such as adhesive materials, latches or fasteners (not shown), or by welding procedures or the like.

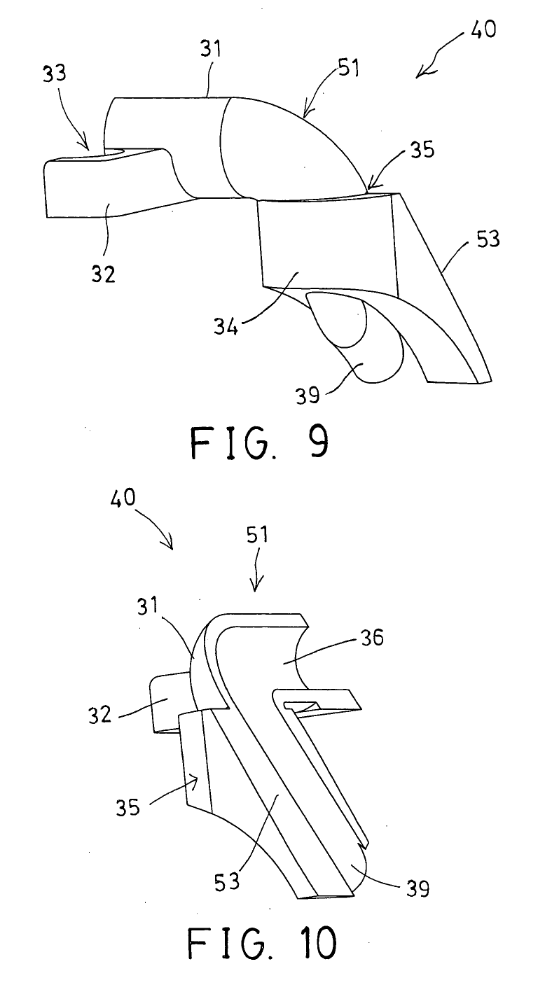

The two half members 40 each may include one half of the tubular member 31 and one half of the ears 32 and one of the blocks 34, and each may further be made or formed by two half segments 50, 51 (FIGS. 4-6 and 7-10), in which the half segments 50, 51 each include one half or a portion of the passage 36 of the half member 40 therein, and may be easily and quickly formed or made with such as molding or mold-injection procedures and with different mold devices, and the half segments 50, 51 may then be secured together with such as adhesive materials, latches or fasteners (not shown), or by welding procedures or the like. It is to be noted that the passage 36 of the tubular member 31 may be opened and exposed in the half segments 50, 51 of the half members 40 such that the half segments 50, 51 may be easily and quickly and precisely formed or made with the molding or mold-injection procedures and may be easily and quickly and readily removed or disengaged from the mold devices. The two half segments 50, 51 each may include a cut flat surface 52, 53 formed therein for being mated and secured together with such as adhesive materials, latches or fasteners (not shown), or by welding procedures or the like.

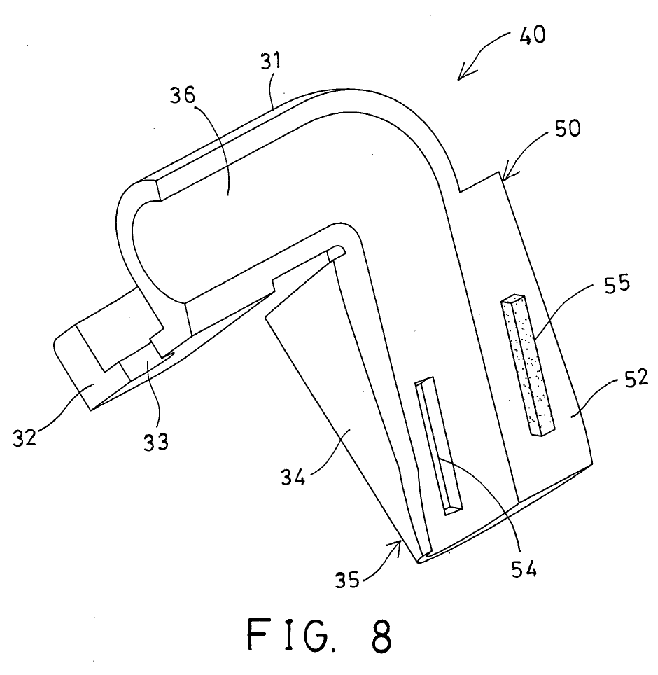

As shown in FIGS. 5-6 and 9-10, the blocks 34 each include a curved or deflecting tongue 39 provided therein for forming a portion of the passage 36 of the tubular member 31 and for suitably directing or guiding the passage 36 of the tubular member 31 toward the inner thread 12 of the ball nut 10 and the outer thread 21 of the screw shaft 20 and for suitably and rotatably and/or movably receiving the rolling or ball bearing members 80 therein. As shown in FIG. 8, the half segment 50 may include a groove 54 formed therein and communicating with the compartment 37 of the block 34 and also communicating with the passage 36 of the tubular member 31 for allowing the lubricating oil or lubricant retained in the compartment 37 of the block 34 to flow into the passage 36 of the tubular member 31 and then to flow into the inner thread 12 of the ball nut 10 and the outer thread 21 of the screw shaft 20 and/or the helical raceway 22 formed between the ball nut 10 and the screw shaft 20. A spongy or oil retaining member 55 may be engaged into the groove 54 of the half segment 50 of each of the half members 40 for suitably retaining and supplying the lubricating oil or lubricant to lubricate the ball bearing members 80.

Accordingly, the ball screw device in accordance with the present invention includes a radially inserted circulating device for separating and for effectively and smoothly receiving and guiding the balls or bearing members to move relative to the ball nut and the screw shaft, and having a structure for allowing the circulating device to be easily and quickly and precisely formed or made with the molding or mold-injection procedures or methods and to be easily and quickly and readily removed or disengaged from the mold devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball screw device comprising:
a screw shaft including an outer thread formed thereon,
a ball nut including a bore formed therein for receiving said screw shaft, and including an inner thread formed therein for forming a helical raceway between said ball nut and said screw shaft, said ball nut including two openings formed therein and communicating with said bore of said ball nut,
a plurality of bearing members received in said helical raceway between said ball nut and said screw shaft for facilitating a rotating movement between said ball nut and said screw shaft, and
a circulating device including a tubular member having two end blocks for engaging into the openings of the ball nut, said tubular member including a passage formed therein and directed toward said inner thread of said ball nut and said outer thread of said screw shaft for receiving said bearing members,
said circulating device including an anti-symmetric structure formed by two half members, and each half member being formed by two half segments each having a portion of the passage of the half member for allowing the half segments of said half member to be formed with molding procedures.

2. The ball screw device as claimed in claim 1, wherein said blocks of said circulating device each include a compartment formed therein for receiving a lubricating oil therein.

3. The ball screw device as claimed in claim 2, wherein said blocks of said circulating device each include a cap for closing said compartment of said block and for retaining said lubricating oil in said compartment of said block.

4. The ball screw device as claimed in claim 2, wherein said blocks of said circulating device each include a groove formed therein and communicating with said compartment of said block and communicating with said passage of said tubular member for allowing said lubricating oil in said compartment of said block to flow into said passage of said tubular member and then to flow into said inner thread of said ball nut and said outer thread of said screw shaft.

5. The ball screw device as claimed in claim 4, wherein said blocks of said circulating device each include an oil retaining member engaged into said groove of each of said blocks of said circulating device.

6. The ball screw device as claimed in claim 1, wherein said blocks of said circulating device each include a deflecting tongue provided therein for forming a portion of said passage of said tubular member and for directing said passage of said tubular member toward said inner thread of said ball nut and said outer thread of said screw shaft.

7. The ball screw device as claimed in claim 1, wherein said circulating device includes at least one ear extended from said tubular member and having an orifice formed therein for engaging with a fastener which detachably secure said circulating device to said ball nut.

8. The ball screw device as claimed in claim 7, wherein said two half members each include one half of said at least one ear provided thereon.
